(19) United States
(12) Patent Application Publication
(10) Pub. No.: US 2014/0120386 A1
(43) Pub. Date: May 1, 2014

(54) Over-Saturated Absorbed Glass Mat Valve Regulated Lead-Acid Battery Comprising Carbon Additives

(71) Applicant: EXIDE TECHNOLOGIES, Milton, GA (US)

(72) Inventors: Sudhakar Jagannathan, Alpharetta, GA (US); John Harold Miller, Johns Creek, GA (US); Layna Lanier Mendlinger, Alpharetta, GA (US); Travis Zachary Torrey, Cumming, GA (US)

(73) Assignee: EXIDE TECHNOLOGIES, Milton, GA (US)

(21) Appl. No.: 13/664,871

(22) Filed: Oct. 31, 2012

(51) Int. Cl. H01M 10/12; H01M 2/16; H01M 2/12; H01M 4/583; B82Y 30/00

(52) U.S. Cl. 429/53; 977/742; 977/734

(57) ABSTRACT

Disclosed herein is a absorbed glass matt (AGM) valve regulated lead-acid (VRLA) battery, comprising: a positive plate comprising a positive active material; a negative plate comprising a negative active material; wherein the negative active material comprises a composition comprising a carbon additive; an AGM separator; and an electrolyte; wherein the positive plate, the negative plate, the separator, and the electrolyte are disposed in a container comprising a valve; and wherein the electrolyte is present in an amount that ranges from 100 to 150% by volume based on the total pore volume of the separator.

### FIELD OF THE INVENTION

An over-saturated valve regulated absorbed glass mat valve-regulated lead-acid battery comprising carbon additives.

### BACKGROUND

Valve Regulated Absorbed Glass Mat (AGM) lead acid batteries are currently manufactured and sold by various lead acid battery manufacturers around the world. AGM is used in various applications including network power installations, marine and cycling applications, automotive Starting/Lighting/Ignition (SLI) applications and a growing presence in Hybrid Electric Vehicle (HEV) applications (Stop-Start, Micro and Mild Hybrid).

The AGM configuration is beneficial in that the electrolyte is generally absorbed and held in glass mat or glass/poly mat separators so that the electrolyte is not free flowing. Generally, the separator operates in a semi-saturated state of 90%-99% saturation. Accordingly, the AGM configuration is advantageous because of the reduced likelihood of spillage and low gassing due to an internal recombination reaction that is allowed by the semi-saturated state.

AGM batteries also provide a cycling benefit that is the result of the plates being held in a tightly compress configuration. The AGM separator acts as a compressible sponge allowing the plates to be held mechanically stable under force. This is of particular interest as applied to HEV applications where the battery is required to support higher levels of electrical support under a cyclical demand routine that is not seen in normal SLI applications.

There are examples in the field of saturated AGM batteries in use, meaning that the AGM system is flooded and that there is excess electrolyte within the cell. (See, e.g., U.S. Pat. No. 6,265,108.) The benefits of this design are that the batteries can support higher water loss rates while in operation as induced by environmental inputs, mainly under hood automotive applications, without water loss induced failure. Under high heat conditions, however, water loss can be a primary failure mode for AGM. There are at least three disadvantages of an AGM system at a 100% saturation level. First, the likelihood of spillage is greater than an AGM system at a semi-saturated state. Second, an AGM system at a 100% saturation level has increased gassing when compared to an AGM system at a semi-saturated state at least because the gas recombination reaction is now by-passed. Third, an AGM system at a 100% saturation level experiences a measurable loss of cycle life.

One of the needs of HEV applications is the requirement for higher rates of charge acceptance. This need is due to higher electrical demand from the battery resulting in deeper states of discharge on the battery. The use of re-generative braking in some HEV applications require high efficiency charge acceptance by the battery so that the regenerative braking energy input can be most fully utilized. Prior advances in improving charge acceptance have focused on the use of “carbon” additives included in the negative electrode. It has been demonstrated that an increase in charge acceptance impacts Partial State of Charge (PSoC) cycling and cycle life. One of the disadvantages of using certain carbon additives is that its use can induce higher rates of gassing, which in turn causes higher rates of water loss, which can result in new failure modes and reduced application life. The mechanism for this higher gassing rate is still unknown but it is shown as real as identified thru standard water consumption lab tests designed to simulate real application usage.

Despite recent advances, it remains a technical challenge to improve the charging/discharging characteristics of an AGM battery. The inventors have sought to overcome this technical challenge by the embodiments disclosed herein.

### SUMMARY

Disclosed herein is an absorbed glass mat (AGM) valve regulated lead-acid (VRLA) battery, comprising: a positive plate comprising a positive active material; a negative plate comprising a negative active material; wherein the negative active material comprises a composition comprising a carbon additive; an AGM separator; and an electrolyte; wherein the positive plate, the negative plate, the separator, and the electrolyte are disposed in a container comprising a valve; and wherein the electrolyte is present in an amount that ranges from 100 to 150% by volume based on the total pore volume of the separator.

### DETAILED DESCRIPTION

### Definitions

The phrase “a” or “an” entity as used herein refers to one or more of that entity; for example, the expression “a positive plate” refers to one or more positive plates, or alternative, at least one positive plate to reflect the plurality commonly associated with “a” or “an.” As such, the terms “a” (or “an”), “one or more”, and “at least one” can be used interchangeably herein.

The terms “optional” or “optionally” as used herein means that a subsequently described event or circumstance may but need not occur, and that the description includes instances where the event or circumstance occurs and instances in which it does not.

Numerical values associated with disclosed and claimed parameters, such as, a specific gravity, a specific surface area, a carbon additive range, a total pore volume, a predominant pore size, a degradation onset temperature, a ratio of the microporosity to the mesoporosity of a carbon additive, an amount of electrolyte, a discharge capacity, a charge acceptance, a state of charge, a voltage, a temperature, etc. are understood to correspond to values subject to measurement and/or observation, which means that associated with said numerical values are standard experimental errors. As such, any such numerical value appearing as a claim term should not be construed to mean that said value is devoid from standard experimental error. The term “about,” as used herein, is intended to express the standard error for a given measurement and/or observable and should be afforded its plain and customary meaning of “approximately.”

The expression, “electrolyte,” as used herein means an aqueous sulfuric acid solution having a specific gravity value that ranges from 1.200 to 1.350.

The expression “semi-saturated,” as used herein means an amount of electrolyte that that ranges from 90 to 99% by volume based on the total pore volume of the separator.

The expression “saturated,” as used herein means an amount of electrolyte that that is 100% by volume based on the total pore volume of the separator.

The expression “over-saturated,” as used herein means an amount of electrolyte that that ranges from 100% to 150% by volume based on the total pore volume of the separator.

The expression “specific surface area,” as disclosed herein means the BET surface area as measured by a low temperature nitrogen adsorption method, based on the original method of Brunauer et al. J. Am. Chem. Soc. (1938) 60(2): 309-319, which has been adopted by ASTM as standard method D 6556.

The expression, “total pore volume,” as used herein means a cumulative value of pore volumes measured at different partial pressures of nitrogen measured using a density functional theory method (DFT) as described in Pure & Appl Chem. (1985) 57(4): 603.

The expression, “microporosity-to-mesoporosity ratio,” as used herein means ratio of pores of sizes (0-20 Å) to pores of sizes (20-500 Å) measured using a density functional theory method (DFT) as described in Pure & Appl Chem. 1985; 57(4): 603.

The term “leady oxide,” as used herein, refers to a milled material comprised of lead and lead oxide.

### Embodiments

A first embodiment disclosed herein is directed to an AGM VRLA battery, comprising: a positive plate comprising a positive active material; a negative plate comprising a negative active material; wherein the negative active material comprises a composition comprising a carbon additive; a separator; and an electrolyte; wherein the positive plate, the negative plate, the separator, and the electrolyte are disposed in a container comprising a valve; and wherein the electrolyte is present in an amount that ranges from 100 to 150% by volume based on the total pore volume of the separator.

Examples of AGM VRLA batteries are known in the art, and include, but are not limited to those described, e.g., in U.S. Pat. No. 6,265,108 and U.S. Published Application No. 2012/0171564.

In a first aspect of the first embodiment, the carbon additive is a graphite, a carbon black, an activated carbon, a carbon nanotube, a graphene, a nano-carbon particle, or combinations thereof.

Examples of graphite include, but are not limited to an expanded graphite (e.g., ABG 1010, available from Superior Graphite), a flake graphite (e.g., APH 2939, also available from Superior Graphite), a high surface area graphite (e.g., HSAG 300 or HSAG 400, available from Timcal AG), etc.

Examples of carbon black include, but are not limited to Printex L6 (available from Evonik), Regal 300R (available from Cabot Corp.), Lamp Black 101 (available from Degussa), etc.

Examples of activated carbon include, but are not limited to mesoporous activated carbon (e.g., Type A-200, Type A-198, Type A1-202, etc.), a microporous activated carbon (e.g., Type B-702, Type B-701, etc.), and other forms of activated carbon available commercially from Norit, such as, for example, NORIT PAC BC, NORIT DLC SUPER 30, NORIT DLC SUPRA 50, etc.

Examples of a carbon nanotube, include but are not limited to a single wall carbon nanotubes XO12UA, XO671UA, P0247 from Carbon Nanotechnologies Inc. and multi-wall carbon nanotubes from Iljin Nanotech company, and Cheaptubes Inc etc.

Examples of graphene, include but are not limited to graphene powder, graphene oxide solution, polar graphene powder from Angstrom Materials etc.

Examples of nano-carbon particles, include but are not limited to C-M-02-NP, C-M-04-NP from American Elements, 0530HT from Skyspring Nanomaterials Inc etc.

In a second aspect of the first embodiment, the carbon additive is a graphite, a carbon black, an activated carbon, or combinations thereof.

In a third aspect of the first embodiment, the carbon additive ranges from 0.1% by weight to 10% by weight based on the total weight of the composition.

In a fourth aspect of the first embodiment, the carbon additive ranges from 0.5% by weight to 3% by weight based on the total weight of the composition.

In a fifth aspect of the first embodiment, the carbon additive has a specific surface area that ranges from 5 m²/g to 50 m²/g, from 250 m²/g to 550 m²/g, from 1000 m²/g to 2000 m²/g, or combinations thereof.

In a sixth aspect of the first embodiment, the carbon additive has a specific surface area that ranges from 5 m²/g to 50 m²/g.

In a seventh aspect of the first embodiment, the carbon additive has a specific surface area that ranges from 250 m²/g to 550 m²/g.

In an eighth aspect of the first embodiment, the carbon additive has a specific surface area that ranges from 1000 m²/g to 2000 m²/g.

In a ninth aspect of the first embodiment, the carbon additive has a total pore volume of at least 0.05 cm³/g and a predominant pore size of less than 20 Å.

In a tenth aspect of the first embodiment, the carbon additive has a total pore volume of at least 0.05 cm³/g and has a predominant pore size that ranges from 20 Å to 500 Å.

In an eleventh aspect of the first embodiment, the carbon additive has a degradation onset temperature that ranges from 500° C. to 750° C.

The degradation onset temperature may be measured by any suitable technique, such, as for example, thermogravimetic analysis.

In a twelfth aspect of the first embodiment, the carbon additive has a degradation temperature that ranges from 100° C. to 300° C.

In a thirteenth aspect of the first embodiment, the carbon additive has a microporosity-to-mesoporosity ratio that ranges from 99:1 to 1:99.

In a fourteenth aspect of the first embodiment, the composition further comprises at least one of:
a leady oxide (in an amount that ranges from 75 wt % to 85 wt %, from 76 wt % to 84 wt %, from 77 wt % to 83 wt %, or from 78 wt % to 82 wt %, based on the total weight of the composition);
sulfuric acid having a specific gravity of 1.400 (in an amount that ranges from 5 wt % to 10 wt %, from 6 wt % to 9 wt %, or from 7 wt % to 8 wt %, based on the total weight of the composition);
a barium sulfate (in an amount that ranges from 0.1 wt % to 1.0 wt %, from 0.2 wt % to 0.9 wt %, from 0.3 wt % to 0.8 wt %, from 0.4 wt % to 0.7 wt %, or from 0.5 wt % to 0.6 wt %, based on the total weight of the composition);
a fiber (in an amount that ranges from 0.05 wt % to 0.1 wt %, from 0.06 wt % to 0.09 wt %, or from 0.07 wt % to 0.08 wt %, based on the total weight of the composition);
an oxylignin (in an amount that ranges from 0.1 wt % to 0.5 wt % or from 0.2 wt % to 0.4 wt %, based on the total weight of the composition);
a carbon black distinct from the carbon additive (in an amount that ranges from 0.1 wt % to 0.5 wt % or from 0.2 wt % to 0.4 wt %); and
water (in an amount that ranges from 8 wt % to 16 wt %, from 9 wt % to 15 wt %, from 10 wt % to 14 wt %, or from 11 wt % to 13 wt %, based on the total weight of the composition).

A leady oxide comprises from 10 wt % to 30 wt % of lead and from 70 wt % to 90 wt % of lead oxide, based on the total weight of the leady oxide.

An oxylignin, known chemically as sodium lignosulfonate, is commercially available, for example, as Vanisperse A.

Examples of suitable fibers include, but are not limited to a fiberglass; a carbon fiber, such as, a pitch based carbon fiber; a synthetic plastic fiber, including but not limited to, an acrylic fiber, and a polyester fiber (e.g., polyester stapled fibers available from Woongjin Chemical Co., Ltd.); a conductive ceramic fiber, or combinations thereof.

In a fifteenth aspect of the first embodiment, the separator comprises a glass fiber, a polymeric fiber, polymeric resin, or combinations thereof.

In a sixteenth aspect of the first embodiment, the separator comprises a glass fiber.

In a seventeenth aspect of the first embodiment, the electrolyte is present in an amount that ranges from 100 to 140% by volume of the total pore volume of the separator.

In an eighteenth aspect of the first embodiment, the electrolyte is present in an amount that ranges from 100 to 130% by volume of the total pore volume of the separator.

In a nineteenth aspect of the first embodiment, the electrolyte is present in an amount that ranges from 100 to 120% by volume of the total pore volume of the separator.

In a twentieth aspect of the first embodiment, the electrolyte is present in an amount that ranges from 100 to 110% by volume of the total pore volume of the separator.

In a twenty-first aspect of the first embodiment, the electrolyte is present in an amount that ranges from a value of 101, 102, 103, 104, or 105% to 140% by volume of the total pore volume of the separator.

In a twenty-second aspect of the first embodiment, the electrolyte is present in an amount that ranges from a value of 101, 102, 103, 104, or 105% to 130% by volume of the total pore volume of the separator.

In a twenty-third aspect of the first embodiment, the electrolyte is present in an amount that ranges from a value of 101, 102, 103, 104, or 105% to 120% by volume of the total pore volume of the separator.

In a twenty-fourth aspect of the first embodiment, the electrolyte is present in an amount that ranges from a value of 101, 102, 103, 104, or 105% to 110% by volume of the total pore volume of the separator.

In a twenty-fifth aspect of the first embodiment, the lead-acid battery has a discharge capacity, as measured by a C/20 discharge rate that ranges from 1% to 20% (from 5% to 20% or from 10% to 20%) greater than an AGM VRLA battery having a semi-saturated separator.

In a twenty-sixth aspect of the first embodiment, the lead-acid battery has a discharge capacity, as measured by a C/20 discharge rate that ranges from 10% to 20% greater than an AGM VRLA battery having a semi-saturated separator and having a carbon additive that ranges from 0.1% by weight to 10% by weight based on the total weight of the negative active material.

In a twenty-seventh aspect of the first embodiment, the lead-acid battery has a charge acceptance 0% to 33% greater than an AGM VRLA battery having a semi-saturated separator, wherein the charge acceptance is tested from 40 to 90% state of charge.

In a twenty-eighth aspect of the first embodiment, the lead-acid battery has a charge acceptance 0% to 33% greater than an AGM VRLA battery having a semi-saturated separator and having a carbon additive that ranges from 0.1% by weight to 10% by weight based on the total weight of the negative active material, wherein the charge acceptance is tested from 40 to 90% state of charge.

In a twenty-ninth aspect of the first embodiment, the electrolyte is present in an amount greater than 100% by volume of the total pore volume of the separator after 6 weeks of a water consumption test performed at a temperature of 60° C. and voltage of 14. V.

In a thirtieth aspect of the first embodiment, the durability, as measured by a repeated reserve capacity test, of the battery increases from 0 to 35% relative to an AGM VRLA battery having a semi-saturated separator.

In a thirty-first aspect of the first embodiment, the durability, as measured by a repeated reserve capacity test, of the battery increases from 0 to 35% relative to an AGM VRLA battery having a semi-saturated separator and having a carbon additive that ranges from 0.1% by weight to 10% by weight based on the total weight of the negative active material.

A lead-acid battery is generally comprised of a plurality of positive plates and a plurality of negative plates in an electrolyte bath. Typically, the positive and negative plates are isolated by a porous separator whose primary role is to eliminate contact between the plates while maintaining a minimal distance (e.g., a few millimeters) between the positive and negative plates. A separator prevents and/or reduces a short-circuit from occurring between the positive and negative plates and reducing the Pb deposits in the bottom of the battery. A separator may comprise dendrites in order to afford puncture resistance. A fully charged, positive lead-acid battery is typically comprised of a electrode plate is typically comprised of lead dioxide, while the negative plate is typically comprised of lead.

In a thirty-second aspect of the first embodiment, the valve is an overpressure valve.

A second embodiment disclosed herein is directed to an AGM VRLA battery, comprising: a positive plate comprising a positive active material; a negative plate comprising a negative active material; a separator; and an electrolyte;

wherein the negative active material comprises a composition comprising (i) a leady oxide, (ii) sulfuric acid having a specific gravity of 1.400, (iii) a barium sulfate, (iv) a fiber, (v) a carbon black, (vi) an oxylignin; (vii) a carbon additive, and (viii) water;

wherein the positive plate, the negative plate, the separator, and the electrolyte are disposed in a container comprising a valve; and

wherein the electrolyte is present in an amount that ranges from 100 to 150% by volume based on the total pore volume of the separator.

In a first aspect of the second embodiment, the carbon additive is a graphite, a carbon black, an activated carbon, a carbon nanotube, a graphene, a nano-carbon particle, or combinations thereof.

In a second aspect of the second embodiment, the carbon additive is a graphite, a carbon black, an activated carbon, or combinations thereof.

In a third aspect of the second embodiment, the carbon additive ranges from 0.1% by weight to 10% by weight based on the total weight of the composition.

In a fourth aspect of the second embodiment, the carbon additive ranges from 0.5% by weight to 3% by weight based on the total weight of the composition.

In a fifth aspect of the second embodiment, the carbon additive has a specific surface area that ranges from 5 m²/g to 50 m²/g, from 250 m²/g to 550 m²/g, from 1000 m²/g to 2000 m²/g, or combinations thereof.

In a sixth aspect of the second embodiment, the carbon additive has a specific surface area that ranges from 5 m²/g to 50 m²/g.

In a seventh aspect of the second embodiment, the carbon additive has a specific surface area that ranges from 250 m²/g to 550 m²/g.

In an eighth aspect of the second embodiment, the carbon additive has a specific surface area that ranges from 1000 m²/g to 2000 m²/g.

In a ninth aspect of the second embodiment, the carbon additive has a total pore volume of at least 0.05 cm³/g and a predominant pore size of less than 20 Å.

In a tenth aspect of the second embodiment, the carbon additive has a total pore volume of at least 0.05 cm³/g and has a predominant pore size that ranges from 20 Å to 500 Å.

In an eleventh aspect of the second embodiment, the carbon additive has a degradation onset temperature that ranges from 500° C. to 750° C.

In a twelfth aspect of the second embodiment, the carbon additive has a degradation temperature that ranges from 100° C. to 300° C.

In a thirteenth aspect of the second embodiment, the carbon additive has a microporosity-to-mesoporosity ratio that ranges from 99:1 to 1:99.

In a fourteenth aspect of the second embodiment, the separator comprises a glass fiber, a polymeric fiber, polymeric resin, or combinations thereof.

In a fifteenth aspect of the second embodiment, the separator comprises a glass fiber.

In a sixteenth aspect of the second embodiment, the electrolyte is present in an amount that ranges from 100 to 140% by volume of the total pore volume of the separator.

In a seventeenth aspect of the second embodiment, the electrolyte is present in an amount that ranges from 100 to 130% by volume of the total pore volume of the separator.

In an eighteenth aspect of the second embodiment, the electrolyte is present in an amount that ranges from 100 to 120% by volume of the total pore volume of the separator.

In a nineteenth aspect of the second embodiment, the electrolyte is present in an amount that ranges from 100 to 110% by volume of the total pore volume of the separator.

In a twentieth aspect of the second embodiment, the electrolyte is present in an amount that ranges from a value of 101, 102, 103, 104, or 105% to 140% by volume of the total pore volume of the separator.

In a twenty-first aspect of the second embodiment, the electrolyte is present in an amount that ranges from a value of 101, 102, 103, 104, or 105% to 130% by volume of the total pore volume of the separator.

In a twenty-second aspect of the second embodiment, the electrolyte is present in an amount that ranges from a value of 101, 102, 103, 104, or 105% to 120% by volume of the total pore volume of the separator.

In a twenty-third aspect of the second embodiment, the electrolyte is present in an amount that ranges from a value of 101, 102, 103, 104, or 105% to 110% by volume of the total pore volume of the separator.

In a twenty-fourth aspect of the second embodiment, the lead-acid battery has a discharge capacity, as measured by a C/20 discharge rate that ranges from 1% to 20% (from 5% to 20% or from 10% to 20%) greater than an AGM VRLA battery having a semi-saturated separator.

In a twenty-fifth aspect of the second embodiment, the lead-acid battery has a discharge capacity, as measured by a C/20 discharge rate that ranges from 10% to 20% greater than an AGM VRLA battery having a semi-saturated separator and having a carbon additive that ranges from 0.1% by weight to 10% by weight based on the total weight of the negative active material.

In a twenty-sixth aspect of the second embodiment, the lead-acid battery has a charge acceptance 0% to 33% greater than an AGM VRLA battery having a semi-saturated separator, wherein the charge acceptance is tested from 40 to 90% state of charge.

In a twenty-seventh aspect of the second embodiment, the lead-acid battery has a charge acceptance 0% to 33% greater than an AGM VRLA battery having a semi-saturated separator and having a carbon additive that ranges from 0.1% by weight to 10% by weight based on the total weight of the negative active material, wherein the charge acceptance is tested from 40 to 90% state of charge.

In a twenty-eighth aspect of the second embodiment, the electrolyte is present in an amount greater than 100% by volume of the total pore volume of the separator after 6 weeks of a water consumption test performed at a temperature of 60° C. and voltage of 14. V.

In a twenty-ninth aspect of the second embodiment, the durability, as measured by a repeated reserve capacity test, of the battery increases from 0 to 35% relative to an AGM VRLA battery having a semi-saturated separator.

In a thirtieth aspect of the second embodiment, the durability, as measured by a repeated reserve capacity test, of the battery increases from 0 to 35% relative to an AGM VRLA battery having a semi-saturated separator and having a carbon additive that ranges from 0.1% by weight to 10% by weight based on the total weight of the negative active material.

In a thirty-first aspect of the second embodiment, the valve is an overpressure valve.

As will be seen from the examples included herein an AGM lead-acid battery made in accordance to the embodiments disclosed herein shows improved properties, which were not heretofore known.

### Examples

An AGM VRLA test battery manufacture involves the following process steps. The carbon-containing paste is prepared by adding lead oxide, one or more carbons, expander and polymeric fibers to a mixing vessel, dry mixing the materials for 2 minutes using a paddle type mixer. Water is added (x % more water than regular negative paste mix for every 1% additional carbon) and mixing is continued. Sulfuric acid with right specific gravity is then sprinkled/sprayed into the mixing vessel with constant stirring and mixing is continued until the paste attains required wet paste density. Viscosity and penetration of the resulting carbon paste is measured and optionally water is added to the paste to attain necessary vinosity. This carbon containing paste is then applied on to lead alloy grid followed by curing process where the plates are subjected to high temperature and humidity. In cylindrical cells, the positive and negative plates are rolled with seperator and/or pasting papers into spiral cells before curing. Cured plates are further dried at higher temperature. Dried plates are assembled as positive and negative plates seperated by advanced glass mat seperator in the battery casing. The battery cells are then filled with correct specific gravity sulphuric acid. Batteries are then formed using formation profile having a series of constant current steps. The batteries are then sealed with a vent caps.

In the examples considered herein, three types of AGM VRLA batteries were prepared using conventional techniques, such as, as described in US 2012/0171564.

The first battery type was a semi-saturated AGM VRLA battery with and without added carbon additive using an amount of electrolyte that was between 93-97% by volume of electrolyte based on the total pore volume of the separator.

A second battery type was an over-saturated AGM VRLA battery containing no carbon additives.

The first and second battery types are not covered by the disclosed embodiments and so are considered to be comparative.

A third battery type was an over-saturated AGM VRLA batteries containing a negative active material comprised of a certain amount of carbon additives.

In the first and third battery types, a certain amount of carbon additive was included as a part of the negative active material, as shown in the following table.

| Label | Carbon Additive |
|---|---|
| A | 0.5% graphite |
| B | 1% graphite |
| C | 2% graphite |
| D | 1.5% graphite + 0.5% carbon black |

A first advantage of an over-saturated AGM VRLA battery containing a certain amount of carbon additive is apparent by considering the 20-hour capacity test results. Briefly, the 20-hour capacity test results were obtained as follows. The discharge capacity of the cell was determined by discharging a fully charged battery at rate (I₂₀) of capacity ratings/20. For example, 100 Ah battery is discharged at 100/20=5 A constant current rate to determine the C20 discharge capacity. During the discharge the cell temperature was maintained in the range of 25±2° C., and the final cut-off voltage was 1.75 V/cell or 10.5 V for a 12V battery. The discharge time (t₂₀) to 1.75 V/cell was used to calculate the discharge capacity at C20 discharge rate using the following equation:

C₂₀=t₂₀×I₂₀ [Ah]

The observed C/20 discharge capacities are presented in Table 1 along with the calculated change (%) comparing C/20 discharge capacity of the semi-saturated AGM VRLA battery to C/20 discharge capacity of the over-saturated (110% electrolyte) AGM VRLA battery.

TABLE 1
C/20 discharge capacity

| | Electrolyte Content | | |
|---|---|---|---|
| | Semi-Saturated | Over-Saturated | |
| | C20 | C20 | Change |
| Example | (Ah) | (Ah) | (%) |
| Comparative (no carbon) | 94.1 | 103.0 | 9.5 |
| A | 90.6 | 101.7 | 12.4 |
| B | 83.2 | 98.7 | 18.6 |
| C | 83.5 | 101.0 | 20.9 |
| D | 80.4 | 96.2 | 19.7 |

Battery Rated Capacity: 92 Ah

The Table 1 results reveal that there is an improvement (9.5%) in the C/20 discharge capacity of an over-saturated AGM VRLA battery when compared to a semi-saturated AGM VRLA battery. AGM VRLA batteries containing an increasing amount of carbon additive (A to D) result in nearly a 15% decrease in the C/20 discharge capacity for the semi-saturated AGM VRLA batteries. However, the same effect is not seen for the over-saturated AGM VRLA batteries. For example, an increase in carbon additive from 0.5% (A) to 2% (D) afforded a nearly constant C/20 discharge capacity for the over-saturated AGM VRLA batteries. Further, a comparison of the C/20 discharge capacities of the semi-saturated AGM VRLA batteries and the over-saturated AGM VRLA at a constant amount of carbon additive reveals a marked increase that ranges from 12.4% to 20.9%.

A second advantage of an over-saturated AGM VRLA battery containing a certain amount of carbon additive is the durability, as measured by a repeated reserve capacity (RRC) test.

The RRC test was performed as follows. The following cycling profile is performed 50 times in at 40±2° C. for Repeated Reserve Capacity or Durability test. The battery is discharged with the constant current of 25 A (±1.0%), until the terminal voltage reaches (10.0±0.1) V. The battery is then IV-charged with a constant voltage of 14.4±0.1 V and limited current of 5×I₂₀ for 12 hours.

Using the RRC-values for the comparative batteries (i.e., no carbon additive) as a base value, the observed RRC test values are expressed as a percentage relative to the battery containing no carbon additive, as shown in Table 2.

TABLE 2
Repeated Reserve Capacity test (% improvement for carbon batteries
over Standard - Cumulative area under the RRC curve)

| | Electrolyte Content | | |
|---|---|---|---|
| | Semi-Saturated | Over-Saturated | Difference |
| Carbon Content | RRC-1 % | RRC-2 % | (%) |
| Comparative (no carbon) | 0.0 | 0.0 | 0.0 |
| A | 7.3 | 8.2 | 0.9 |
| B | 10.0 | 21.4 | 11.5 |
| C | 8.7 | 23.8 | 15.2 |
| D | 3.9 | 38.1 | 34.2 |

In this table a given RRC-1 value refers to the RRC test-value of the semi-saturated AGM VRLA battery having a certain amount of carbon additive relative to the semi-saturated AGM VRLA battery having no carbon additive. Additionally, a given RRC-2 value refers to the RRC test-value of the over-saturated (110% electrolyte) AGM VRLA battery having a certain amount of carbon additive relative to the RRC test value of an over-saturated AGM VRLA battery having no carbon additive.

The data presented in Table 2 reveals that for the semi-saturated AGM VRLA battery, increasing the carbon additive content provides for maximum improvement in the durability of about 10.0% (B). However, a more pronounced effect is seen for an over-saturated AGM VRLA battery having a carbon additive content from 0.5% (A, 8.2%) to 2.0% (C, 23.8%). The results for D (1.5% graphite and 0.5% carbon black) show an even higher level of durability (38.1%) compared to an over-saturated AGM VRLA battery containing no carbon additive (3.9%). Finally, the results reveals that in all instances, the over-saturated AGM VRLA battery containing a certain amount of carbon additive has a greater durability when compared to the semi-saturated AGM VRLA battery containing the same amount of carbon additive, with the carbon additive (D) having the most pronounced effect.

An additional advantage of an over-saturated AGM VRLA battery containing a certain amount of carbon additive is apparent from a water consumption test. The water consumption test was performed on the AGM VRLA batteries as follows. The battery was charged continuously at 14.4±0.05 V for 12 weeks in a water bath maintained at 60+2° C. The batteries are weighed every week after drying externally and weight loss or water consumption corresponding to overcharge conditions are determined. The water consumption is reported as the weight loss in grams per rated ampere-hour of the battery.

Table 3 provides the results of the water consumption tests over a 12-week period for an over-saturated AGM VRLA battery (110% electrolyte) having no carbon additives and the over-saturated (110% electrolyte) AGM VRLA batteries having a certain amount of carbon additives. In this test, the permissible water loss limit after 6 weeks is 3.0 g/Ah.

TABLE 3
Water Consumption Test Results at a Constant
Voltage of 14.4 V (60° C.)

| | Battery Weight Loss (g/Ah) | | | | |
|---|---|---|---|---|---|
| | Comp. | | | | |
| Week | Ex. | A | B | C | D |
| 0 | 0 | 0 | 0 | 0 | 0 |
| 1 | 0.2 | 0.4 | 0.2 | 0.6 | 0.6 |
| 2 | 0.3 | 0.6 | 0.5 | 0.9 | 1.0 |
| 3 | 0.4 | 0.8 | 0.8 | 1.3 | 1.4 |
| 4 | 0.5 | 0.9 | 0.9 | 1.7 | 1.9 |
| 5 | 0.6 | 1.0 | 1.1 | 2.0 | 2.7 |
| 6 | 0.6 | 1.0 | 1.1 | 2.1 | 3.5 |
| 7 | 0.7 | 1.1 | 1.2 | 2.8 | 4.1 |
| 8 | 0.9 | 1.2 | 1.4 | 2.8 | 4.3 |
| 9 | 1.0 | 1.2 | 1.5 | 3.1 | 4.4 |
| 10 | 1.1 | 1.3 | 1.6 | 3.2 | 4.5 |
| 11 | 1.2 | 1.4 | 1.8 | 3.3 | 4.6 |
| 12 | 1.3 | 1.4 | 1.9 | 3.3 | 4.8 |

These results reveal that an over-saturated AGM battery having a single carbon additive (graphite) in an amount ranging from 0.5% to 2% exhibit an acceptable water loss with all values being less than 3.0 g/Ah over a six-week period. Of course, it should be noted that an over-saturated AGM VRLA battery can experience a greater degree of water loss because an over-saturated AGM VRLA battery contains more than about 2 lbs. of electrolyte when compared to a semi-saturated AGM VRLA battery.

An additional advantage of an over-saturated AGM VRLA battery containing a certain amount of carbon additive is apparent from a dynamic charge acceptance test. The dynamic charge acceptance test was performed on the AGM VRLA batteries as follows. A fully discharged battery is discharged with a constant current of 2×I20 (±1.0%) for 1 hour (i.e. for 10%) at a temperature of (25+2/−0)° C. to get the battery to 90% state of charge (SoC) Immediately after the discharge the battery is charged with a constant voltage of (14.8±0.05) V for 60 seconds with current limited to 200 A, at a temperature of (25+2/−0)° C. The charging current was recorded for 60 seconds with a sampling rate of at least 10 Hz. Then the battery is further discharged with a constant current of 2×120 (±1.0%) for 1 hour (i.e. for 10%) at a temperature of (25+2/−0)° C. to get the battery to 80% state of charge (SoC) Immediately after the discharge the battery is charged with a constant voltage of (14.8±0.05) V for 60 seconds with current limited to 200 A, at a temperature of (25+2/−0)° C. The charging current was recorded for 60 seconds with a sampling rate of at least 10 Hz. This procedure is repeated until 60% of capacity is discharged (6 repetitions). The charge acceptance is presented by the current battery is drawing at the end of 60 second charge period.

The results of these tests are presented in Table 4.

TABLE 4
Dynamic Charge Acceptance (DCA)
(Current at 60 seconds at various State of Charges, SoC)

| | Semi-Saturated | | | | |
|---|---|---|---|---|---|
| SoC | DCA_{NCA} | DCA_{A} | DCA_{B} | DCA_{C} | DCA_{D} |
| 90 | 52.8 | 51.4 | 44.0 | 50.3 | 50.1 |
| 80 | 88.2 | 86.0 | 72.1 | 81.2 | 79.2 |
| 70 | 122.4 | 119.8 | 101.8 | 113.0 | 109.2 |
| 60 | 160.3 | 157.6 | 135.2 | 149.7 | 142.6 |
| 50 | 190.3 | 198.6 | 172.3 | 190.5 | 181.2 |
| 40 | 200.0 | 200.0 | 200.0 | 200.0 | 200.0 |
| | Over-Saturated | | | | |
| | DCA′_{NCA} | DCA′_{A} | DCA′_{B} | DCA′_{C} | DCA′_{D} |
| 90 | 69.9 | 64.0 | 61.5 | 64.1 | 64.1 |
| 80 | 121.5 | 111.9 | 107.1 | 109.8 | 109.8 |
| 70 | 165.8 | 159.4 | 152.0 | 155.1 | 155.1 |
| 60 | 200.0 | 200.0 | 194.9 | 172.3 | 172.3 |
| 50 | 200.0 | 200.0 | 200.0 | 175.7 | 175.7 |
| 40 | 200.0 | 200.0 | 200.0 | 178.6 | 178.6 |

Change (%)

| | | | | | |
|---|---|---|---|---|---|
| 90 | 24.5 | 19.6 | 28.5 | 21.5 | 21.9 |
| 80 | 27.4 | 23.2 | 32.7 | 26.1 | 27.9 |
| 70 | 26.2 | 24.8 | 33.0 | 27.1 | 29.6 |
| 60 | 19.9 | 21.2 | 30.6 | 13.1 | 17.3 |
| 50 | 4.9 | 0.7 | 13.9 | −8.4 | −3.1 |
| 40 | 0.0 | 0.0 | 0.0 | −12.0 | −12.0 |

Table 4 provides the observed dynamic charge acceptance (DCA) values for a semi-saturated AGM VRLA battery containing no carbon additive (DCA_{NCA}, NCA=no carbon additive). The table also provides the observed dynamic charge acceptance (DCA) values for semi-saturated AGM VRLA batteries containing a certain amount of carbon additive (A to D). These values are comparative.

Table 4 also includes the observed dynamic charge acceptance (DCA′) values for the over-saturated (electrolyte=110%) AGM VRLA batteries containing no carbon additive (DCA′_{NCA}), as well as the observed DCA′ values for over-saturated AGM VRLA batteries a certain amount of carbon additive (A to D).

The difference between the DCA values and the DCA′ values is expressed by a percentage, which is calculated according to the following equation:

$$Change ( \% ) = 100 * ( \frac{{DCA}_{n}^{′} - {DCA}_{n}}{{DCA}_{n}} )$$

where n represents a certain battery having a particular carbon additive loading, as noted above. The results reveal that an over-saturated AGM VRLA battery containing a carbon additive has a charge acceptance 0% to 33% greater than a semi-saturated AGM VRLA battery when tested between 40 to 90% state of charge.

The results presented herein reveal that exemplified embodiments of the AGM VRLA batteries disclosed herein will allow the cycling benefits of a compressed AGM system to be paired with the charge acceptance and PSoC cycling benefits allowed by certain carbon additives while compensating for the higher water loss rates by providing the battery with excess electrolyte.

The subject matter of US 2012/0171564 (U.S. Ser. No. 12/984,023, filed on Jan. 4, 2011) is hereby incorporated by reference. The individual components shown in outline or designated by blocks in the Drawings disclosed in US 2012/0171564 are all well-known in the battery arts, and their specific construction and operation are not critical to the operation or best mode for carrying out the invention. The subject matter of U.S. Pat. No. 6,265,108 is hereby incorporated by reference.

Although a full and complete description is believed to be contained herein, certain patent and non-patent references may include certain essential subject matter. To the extent that these patent and non-patent references describe essential subject matter, these references are hereby incorporated by reference in their entirety. It is understood that the meanings of the incorporated subject matter are subservient to the meanings of the subject matter disclosed herein.

The foregoing description provides illustration and description, but is not intended to be exhaustive or to limit the claimed subject matter. Modifications and variations are possible in light of the above teachings or may be acquired from practice of the invention. Thus, it is noted that the scope of the invention is defined by the claims and their equivalents.

What is claimed is:

1. An absorbed glass matt (AGM) valve regulated lead-acid (VRLA) battery, comprising:
a positive plate comprising a positive active material;
a negative plate comprising a negative active material;
wherein the negative active material comprises
a composition comprising a carbon additive;
an AGM separator;
and an electrolyte;
wherein the positive plate, the negative plate, the separator, and the electrolyte are disposed in a container comprising a valve; and
wherein the electrolyte is present in an amount that ranges from 100 to 150% by volume based on the total pore volume of the separator.

2. The battery of claim 1, wherein carbon additive is a graphite, a carbon black, an activated carbon, a carbon nanotube, a graphene, or a nano-carbon particle, or combinations thereof.

3. The battery of claim 1, wherein carbon additive is a graphite, a carbon black, an activated carbon, or combinations thereof.

4. The battery of claim 1, wherein the carbon additive ranges from 0.1% by weight to 10% by weight based on the total weight of the composition.

5. The battery of claim 1, wherein the carbon additive ranges from 0.5% by weight to 3% by weight based on the total weight of the composition.

6. The battery of claim 1, wherein the carbon additive has a specific surface area that ranges from 5 m²/g to 50 m²/g, from 250 m²/g to 550 m²/g, from 1000 m²/g to 2000 m²/g, or combinations thereof.

7. The battery of claim 1, wherein the carbon additive has a specific surface area that ranges from 5 m²/g to 50 m²/g.

8. The battery of claim 1, wherein the carbon additive has a specific surface area that ranges from 250 m²/g to 550 m²/g.

9. The battery of claim 1, wherein the carbon additive has a specific surface area that ranges from 1000 m²/g to 2000 m²/g.

10. The battery of claim 1, wherein the carbon additive has a total pore volume of at least 0.05 cm³/g and a predominant pore size of less than 20 Å.

11. The battery of claim 1, wherein the carbon additive has a total pore volume of at least 0.05 cm³/g and has a predominant pore size that ranges from 20 Å to 500 Å.

12. The battery of claim 1, wherein the carbon additive has a degradation onset temperature that ranges from 500° C. to 750° C.

13. The battery of claim 1, wherein the carbon additive has a degradation temperature that ranges from 100° C. to 300° C.

14. The battery of claim 1, wherein the carbon additive has a microporosity-to-mesoporosity ratio that ranges from 99:1 to 1:99.

15. The battery of claim 1, wherein the separator comprises a glass fiber, a polymeric fiber, polymeric resin, or combinations thereof.

16. The battery of claim 1, wherein the separator comprises a glass fiber.

17. The battery of claim 1, wherein the electrolyte is present in an amount that ranges from 100 to 140% by volume of the total pore volume of the separator.

18. The battery of claim 1, wherein the electrolyte is present in an amount that ranges from 100 to 130% by volume of the total pore volume of the separator.

19. The battery of claim 1, wherein the electrolyte is present in an amount that ranges from 100 to 120% by volume of the total pore volume of the separator.

20. The battery of claim 1, wherein the electrolyte is present in an amount that ranges from 100 to 110% by volume of the total pore volume of the separator.

21. The battery of claim 1, the lead-acid battery has a discharge capacity, as measured by a C/20 discharge rate, that ranges from 10% to 20% greater than an AGM VRLA battery having a semi-saturated separator.

22. The battery of claim 1, wherein the lead-acid battery has a charge acceptance 0% to 33% greater than an AGM VRLA battery having a semi-saturated separator, wherein the charge acceptance is tested from 40 to 90% state of charge.

23. The battery of claim 1, wherein the electrolyte is present in an amount greater than 100% by volume of the total pore volume of the separator after 6 weeks of a water consumption test performed at a temperature of 60° C. and voltage of 14. V.

24. The battery of claim 1, wherein the durability, as measured by a repeated reserve capacity test, of the battery increases from 0 to 35% relative to an AGM VRLA battery having a semi-saturated separator.
